(19) United States
(12) Patent Application Publication
(10) Pub. No.: US 2005/0108384 A1
(43) Pub. Date: May 19, 2005

(54) Analysis of message sequences

(76) Inventors: John R. Lambert, Bellevue, WA (US); Luis Felipe Cabrera, Bellevue, WA (US)

Correspondence Address: LEE & HAYES PLLC, 421 W RIVERSIDE AVENUE SUITE 500, SPOKANE, WA, 99201, US

(21) Appl. No.: 10/692,265

(22) Filed: Oct. 23, 2003

(51) Int. Cl. G06F 15/173

(52) U.S. Cl. 709/224

(57) ABSTRACT

A method and apparatus are described for investigating the behavior of an environment by analyzing messages passed between participants in the environment. The environment can pertain to a network, a machine, a system, a software program, or other environment. The analysis can use any kind of analysis to group sequences of messages into a collection of related sequences. The results of the analysis may reveal anomalous conditions within the environment, or other features of the environment.

### TECHNICAL FIELD

This subject matter relates to automated analysis techniques, and in a more particular implementation, to automated techniques for investigating the behavior of data processing systems, such as computer systems.

### BACKGROUND

Analysts commonly apply one or more techniques for investigating the behavior of data processing systems. An analyst may apply such techniques to determine whether a data processing system is working properly. Functional tests ensure that the data processing system is producing expected results. Performance-related tests ensure that the data processing system is producing the expected results in a desired manner (such as within a particular period of time, etc.). Alternatively, the analyst may apply investigation techniques in an open-ended manner to explore the behavior of the data processing system to determine its salient characteristics (e.g., without necessarily comparing this behavior with predefined expectations). These techniques can be applied to any kind of data processing system, included computers running software programs, networks of such computers, data processing equipment included hardwired (non-programmable) processing logic, or other kinds of processing device(s).

An analyst can select from a great variety of strategies in investigating the behavior of a data processing system. Many of these strategies require a priori knowledge of the features of the system under investigation and its output. One class of such techniques constructs a model of the system under consideration to provide a baseline that defines the expected behavior of the system. This class of techniques then measures the actual behavior of the system and compares it with the baseline model. Discrepancies between measured and expected results may suggest that the system is not working properly. For instance, such a technique may analyze the messages output from a data processing system under test and then compare such messages with a model that defines the expected form and content of such messages to determine whether the system is operating properly.

The above-described solution may not be able to diagnose problems in some kinds of data processing systems. Consider, for example, the case of a data processing system that includes multiple computer devices interacting with each other via a network. Two computers may be transmitting messages with each other that have the correct data type and content. Nevertheless, the timing at which these messages are being transmitted and received, or the ordering or number of such messages, may suggest that there is some anomaly within the data processing system; this anomaly cannot be detected by simply examining the form of each individual message being transmitted. Furthermore, an analyst may wish to investigate the behavior of a data processing system that the analyst cannot gain direct access to, and therefore the analyst may not know the details of its configuration. Therefore, the analyst may be unaware, beforehand, of what messages and message sequences are valid (properly formed) and what messages and message sequences are invalid (improperly formed).

Another class of investigation techniques may apply formal methods of message analysis based on a finite state machine. However, it may be difficult or impossible to construct such a state machine for many data processing machines. It may be particularly difficult to construct such a model where the behavior of the system is non-deterministic, or where the model must also account for systems which permit message retries. Further, as in the first class of techniques, building a finite state machine requires advance knowledge of the configuration of the data processing system. This class of techniques therefore does not work in cases where the analyst cannot determine the configuration of the data processing system (because, for instance, the data processing system is a network resource that is owned and maintained by an entity not under the control of the analyst).

Another class of techniques captures some kind of code profile of the system under consideration, such as an operational profile or execution profile. These techniques then analyze various features in the profile. For example, one known technique analyzes the behavior of a standalone system by applying test instrumentation to count function calls. This test instrumentation can be implemented with code that interacts with the code of the system under test. There are drawbacks to this class of techniques as well. For instance, this solution requires invasive instrumentation to monitor the internal behavior the data processing system. Again, where the data processing system in not under control of the analyst, this solution might not be possible or feasible. Further, different data processing systems may adopt different versions of a software program. In this case, test instrumentation adapted to interact with one version of the software program might not work well (or at all) with another version of the software program. Further, the test results generated by one version may not be directly comparable to the test results generated by another version of the program. These differences complicate the monitoring and analysis of the behavior of the system, because the analyst must specifically tailor his or her test strategy to account for these differences (such as by selecting test instrumentation that is adapted to work with different versions, and then harmonizing the test results between different versions).

As such, there is an exemplary need in the art for a more efficient, effective, and/or flexible technique for investigating the operational characteristics of data processing systems.

### SUMMARY

According to one exemplary implementation, a method is described for investigating messages passed in a message-passing environment. The method can involve: (1) collecting a plurality of messages from at least one participant in the message-passing environment; (2) assembling the messages into at least one message sequence; (3) analyzing said at least one message sequence to extract information regarding the message-passing environment; and (4) outputting the information to a user.

A related apparatus and computer readable media are also described herein.

In some message-passing environments, the messages can be intercepted at locations between participants in the message exchange. Accordingly, this analysis technique may not need to account for the configuration complexities of any participant. Further, in some environments, this analysis technique may work even though the analyst does not have access to the systems used by one or more participants in the message-passing environment. Additional benefits of this approach are identified in the following discussion.

### BRIEF DESCRIPTION OF THE DRAWINGS

FIG. 1 shows an exemplary system for investigating the behavior of a data processing environment by analyzing messages passed between participants in this environment.

FIG. 2 shows four exemplary data processing environments that the system of FIG. 1 can be applied to.

FIG. 3 shows exemplary message analysis logic and a message sequence data store for use in the system of FIG. 1.

FIG. 4 shows an exemplary method for investigating the behavior of a data processing environment using, for instance, the system of FIG. 1.

FIG. 5 shows an exemplary output of the method shown in FIG. 4.

FIG. 6 shows an exemplary computing environment for implementing the system of FIG. 1.

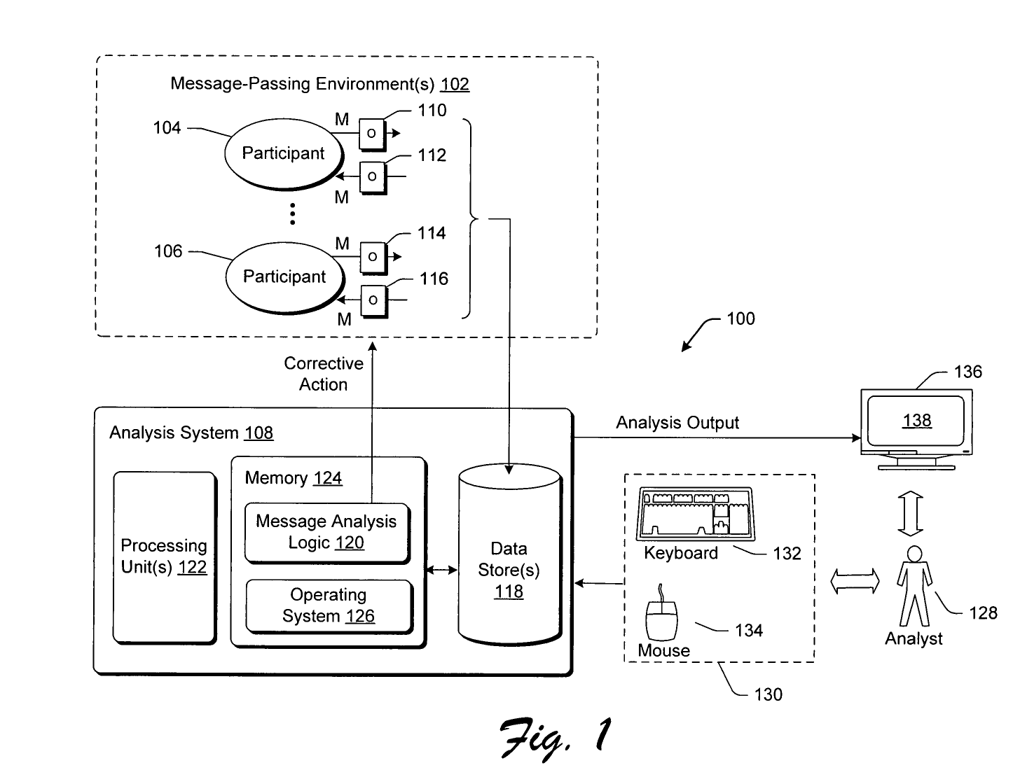

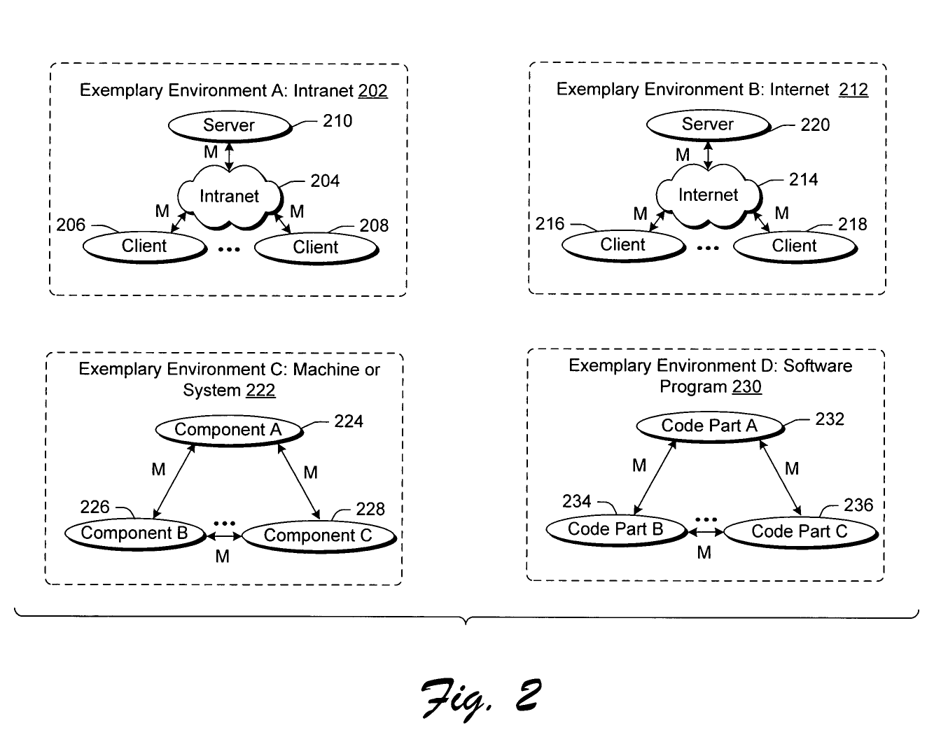

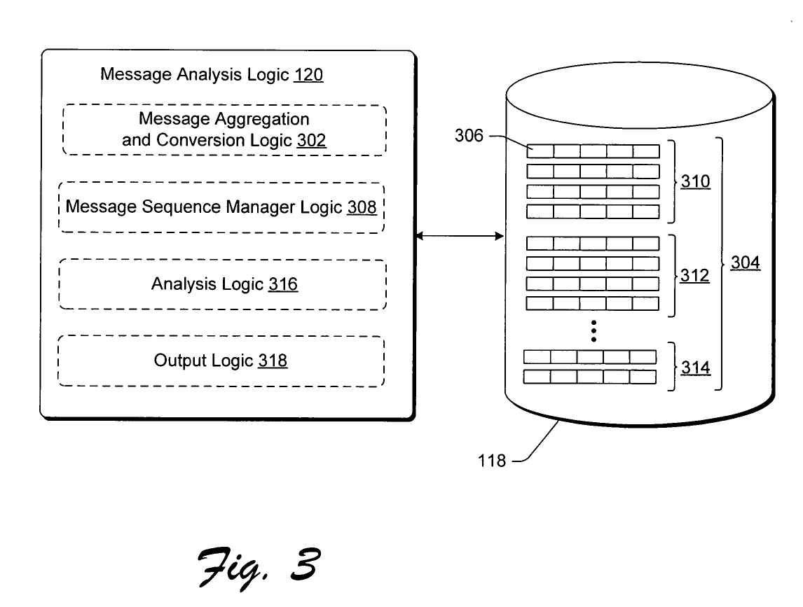

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

A. Exemplary System for Performing Message-Based Analysis

FIG. 1 shows an exemplary system 100 for investigating a message-passing environment 102. By way of overview, the message-passing environment 102 is shown as including at least two participants (104, 106). These participants (104, 106) transmit messages (M) to each other (or, in some cases, to multiple participants in broadcast mode, and in other cases, to themselves). An analysis system 108 collects these messages via various observation agents (O) (e.g., 110, 112, 114, 116) and then groups them into sequences for storage in a data store 118. Message analysis logic 120 analyzes these message sequences and forms an output result based thereon.

The output result can provide insight into the behavior of the message-passing environment 102. For instance, the output result may group similar message sequences together using cluster analysis or some other technique. From this cluster analysis, the message analysis logic 120 can provide an indication of any message sequences which may differ substantially from others. These outlying message sequences may represent an anomalous and undesired condition within the message-passing environment 102. More specifically, the anomalous condition may suggest that certain modules of the message-passing environment 102 are outputting incorrect results, or are providing correct results yet providing the results in an inefficient manner (e.g., either by taking too long to provide the results or by consuming too much system resources in generating the results). Corrective action can be taken on the basis of the output of the message analysis logic 120.

The above-described analysis strategy has numerous advantages compared to the kinds of techniques described in the Background section of this disclosure. For instance, analysis is based on the flow of messages passed between participants, rather than an in-depth knowledge of the configuration of each participant. Hence, meaningful information can be extracted from the message-passing environment even though the analyst does not know the precise configuration of each participant. Indeed, the analyst might not even have knowledge of the identity of an entity sending or receiving a message (as well as any intermediary agents that may process the message en route from sender to receiver). This aspect of the strategy simplifies the investigation because the analyst need no longer generate a model of the system being tested in order to analyze its behavior. An analyst also need not be concerned when participants are running different versions of a common software product, as the investigation is based on the communication between participants, rather than the configuration of each participant per se.

Further, in some cases, messages can be collected at locations “on the wire” between participants. Thus, an analyst might be able to collect meaningful information from the message-passing environment 102 even though the analyst does not have authority or the ability to directly access the systems provided by each participant. This is a particularly attractive feature when analyzing behavior of wide area network systems based on traffic on the network, as the messages may originate and pass through a great number of processing agents that are not under the direct control of the analyst.

The reader will appreciate that there are additional merits to the system and method described herein.

After the above overview, the remainder of this section (i.e., Section A) provides further details regarding the system-level aspects of the analysis strategy. Section B provides additional details regarding the operation of the system. Section C discusses exemplary applications of the system. And Section D describes an exemplary computing environment for implementing features of the system.

To begin with, jumping ahead briefly to FIG. 2, this figure shows four exemplary and non-limiting message-passing environments that can be investigated using the system 100 shown in FIG. 1. That is, the exemplary four message-passing environments shown in FIG. 2 provide specific cases of the generic message-passing environment 102 shown in FIG. 1.

Exemplary environment A (202) pertains to an intranet environment. In this environment 202, a plurality of participants can communicate with each other via an intranet 204. An intranet refers to a network that operates based on TCP/IP protocols within the confines of an enterprise environment, such as a corporation or other organization. A firewall prevents members outside of this environment from accessing the resources of the intranet 204. The exemplary intranet 204 shown in FIG. 2 connects a collection of client devices (e.g., clients 206, 208) with one or more servers (e.g., server 210). In this environment 202, the analysis system 108 can collect and analyze messages transmitted between the clients (206, 208) or between the clients (206, 208) and the server (210).

Exemplary environment B (212) pertains to a wide-area network environment. In this environment 212, a plurality of participants can communicate with each other via the Internet 214. The Internet refers to a network that operates based on TCP/IP protocols and is accessible to a large number and generally unrestricted group of worldwide participants. For purposes of illustration, the Internet 214 shown in FIG. 2 connects a collection of client devices (e.g., clients 216, 218) with one or more servers (e.g., server 220). In this environment 212, the analysis system 108 can collect and analyze messages transmitted between the clients (216, 218) or between the clients (216, 218) and the server (220).

Environments A (202) and B (212) are not exhaustive of the network environments that can be tested using the analysis system 108. Any kind of network environment can be tested, including various LAN-type networks, Ethernet networks, wireless networks, and so on. Further, the network environments (202, 212) shown in FIG. 2 are highly simplified to facilitate discussion. In reality, these environments will include other equipment, such as various routers, interfaces, gateways, and so on.

Exemplary environment C (222) pertains to a single machine including a plurality of components, or one or more systems including a plurality of components. A “component” as used herein can refer to any kind of equipment, such as a discrete data processing device (e.g., a computer, memory device, router, etc.) or a part of a device (such as a CPU, disk drive, RAM memory, various buses, external data stores, and so on). In the simplified and illustrative case of FIG. 2, such a machine or a system includes component A (224), component B (226), and component C (228) in cooperative communication with each other via messages. Any one of these components can assume the role of client, server, or some other role. In this environment 222, the analysis system 108 can collect and analyze messages transmitted between the components (224, 226, and 228). Such messages can thus be internal to the machine or the system. Accordingly, in this environment 222, collecting these messages may require access to the machine or system (and therefore the investigation of this environment 222 may be more intrusive compared to environments 202 and 212).

Exemplary environment D (230) pertains to a software module including a plurality of components. A “component” as used herein can refer to any collection of program instructions in any programming language, or any collection of declarative statements expressed in any declarative language (such as the extensible markup language, i.e., XML). In the simplified and illustrative case of FIG. 2, such a software module includes component A (232), component B (234), and component C (236) in cooperative communication with each other via messages, which may comprise functions calls, messages passed between objects in an object oriented language, and so on. Any one of these components can assume the role of client, server, or some other role. In this environment 230, the analysis system 108 can collect and analyze messages transmitted between the components (232, 234, and 236). Such messages can thus be internal to the machine or machines that implement the software program. Accordingly, like the last case 222, collecting these messages may require access to the machine(s).

Returning to the general depiction of the message-passing environment 102 in FIG. 1, the observation agents (110, 112, 114, 116) can be located throughout the environment 102. In one implementation, observation agents can be placed at locations that enable the analysis system 108 to intercept the messages between participants, e.g., after they are transmitted by a sender and before they are received by a receiver. In a network environment (such as environments 202 and 212), this can be performed by positioning the observation agents in the network at some intermediate point, such as a gateway, a router, at specialized monitoring equipment, or some other intermediary location. This intermediary location can be associated with the sender entity, the recipient entity, or some independent entity (such as the analyst). The entirety of the transmitted messages can be captured or just parts of the messages (such as parts of the headers or parts of the bodies of the messages).

In the machine environment (e.g., environment 222), messages can be intercepted by monitoring information transmitted on lines coupling the components together, or through some other mechanism.

In the code environment (e.g., environment 230), messages can be intercepted by providing specialized software that extracts the messages during the execution of the software, or through some other mechanism. For instance, this specialized software can intercept messages passed to various subroutines, functions, software objects, interfaces, buffers, logs, message stacks, etc.

In one implementation, the observation agents (110, 112, 114, 116) can be turned on and off by a central administrator to suit different analysis needs. In this case, an analyst can “turn off” those observation agents that are not needed, so as not to unduly complicate the operation of the message-passing environment 102.

Whatever the case, FIG. 1 shows that each participant can include two observation agents. A first observation agent can detect messages transmitted by the participant (as in the case of observation agents 110 and 114), and a second observation agent can detect messages received by the participant (as in the case of observation agents 112 and 116). In other implementations, a single observation agent can be designed and/or positioned within the network so as to record both inbound and outbound messages. In one case, the observation agents (110, 112, 114, 116) can detect every message transmitted from or received by the participants (104, 106) in a specified timeframe. In another case, the observation agents (110, 112, 114, 116) may sample the messages transmitted from or received by the participants (104, 106); the timing of this sampling can be governed by predefined rules or can be random.

Messages can be transmitted to the data store 118 using any mechanism, e.g., via hardwired and propriety communication lines, via any kind of network, via wireless transmission, and so on.

The analysis system 108 itself can comprise any kind of data processing system, such as a programmable computer device, a piece of equipment including hardwired logic circuitry, or some combination of programmable computer and hardwired logic circuitry. Generally, the analysis system 108 includes one or more processing units 122 (e.g., CPUs) and system memory 124 (e.g., Random Access Memory (RAM), etc.). During operation, the memory 124 can store an operating system 126 that handles the background tasks of the analysis system 108. The analysis system 126 can also store the message analysis logic 120. The data store 118 can comprise any type of memory device and any associated data management software associated therewith. The analysis system 108 may provide the data store 118 at a remote location with respect the message analysis logic 120, or at the same location as the message analysis logic 120. The data store 118 itself can include a single repository of information or several distributed repositories of information.

An analyst 128 interacts with the analysis system 108 via a collection of input devices 130, such as a keyboard 132, mouse device 134, or other kinds of input device. The analyst 128 also interacts with the analysis system 108 via display monitor 136. Display monitor 136 can provide instructions to the analyst 128, receive input (e.g., via a touch sensitive screen), and present analysis output results for reviewing by the analyst 128. The analysis system 108 can present the above-described information to the analyst 128 in the form of text output, a graphical user interface 138, or some other form. The analysis system 108 can also output information to other devices, such as printers, remote storage devices, remote computers, and so on.

FIG. 3 depicts the message analysis logic 120 and the data store 118 in greater detail. The message analysis logic 120 can be implemented as a software program comprising a plurality of program statements or declarative statements. This software program, in turn, can be conceptualized as including a number of modules for handling different functions performed by the message analysis logic 120. Each of these modules can include a subset of the software program's instructions/statements.

Broadly speaking, message aggregation and conversion logic 302 receives message information from the observation agents (110, 112, 114, 116) and aggregates individual messages in this information into different groups. More specifically, a message (M) can comprise a discrete chunk of information sent from a participant X to a participant Y with a specific action (or command) and, optionally, other information. For example, in network environments, a single message may be formatted using the Simple Object Access Protocol (SOAP). SOAP provides a lightweight protocol to transfer information over networks or other kind of distributed environments. This protocol provides an extensible messaging framework using XML to provide messages that can be sent on different kinds of underlying protocols. Each SOAP message includes a header block and a body element. When transmitted over a network, the SOAP message may also acquire additional header information attributed to protocols used by the network (such as TCP/IP addressing information). Additional information regarding the SOAP protocol is provided in the document SOAP Version 1.2 Part 1: Messaging Framework, dated Jun. 24, 2003, and available at W3C's web site. However, the transmission of messages using SOAP is merely one illustrative example; other protocols and formats can be used. Generally, in any format, a message can be conceptualized as including two pieces of information: a first piece pertains to the transfer of information over the exchange (such as message source, message destination, time, identification number(s), etc.); and a second piece pertains to the specific operation or action being performed in the message exchange (such as information regarding an online purchase, etc.). (The action associated with the message can be gleaned from either the header or body of the message.)

In one implementation, the message aggregation and conversion logic 302 receives message information from the participants in the form of “message traces.” A participant message trace refers to a series of messages originating from or sent to a specific participant, ordered by time. For instance, participant 104 (shown in FIG. 1) might send a trace to the message analysis logic 120 that contains ten minutes worth of SOAP messages sent by it, and/or received by it. In one implementation, a trace may contain all of the information in the intercepted messages. In another implementation, a trace may contain only some information excerpted from the messages, such as information extracted from the header and/or the body of SOAP messages. A trace may or may not include an uninterrupted series of messages transmitted from or received by a participant; for instance, in the case that information is collected from an observation agent that only randomly samples messages, then the trace will not contain an uninterrupted series of messages (that is, because some of the messages have not been captured).

The traces are further arranged into so-called message sequences by the message aggregation and conversion logic 302. The term “message sequence” is used liberally herein to refer to any grouping of one or more messages received from the message-passing environment 102 based on any criteria. For instance, a particular message transaction between a client and server may require a series of messages between these two participants. A message sequence can be compiled that corresponds to this sequence. In another case, a message sequence can be compiled that pertains to messages transmitted to or received by one or more participants in a specified time frame, regardless of the nature of the transactions taking place. Still other bases for forming sequences are possible based on other combinations of criteria. Generally, however, the sequences are formed and ordered, at least in part, based on chronological information in the messages.

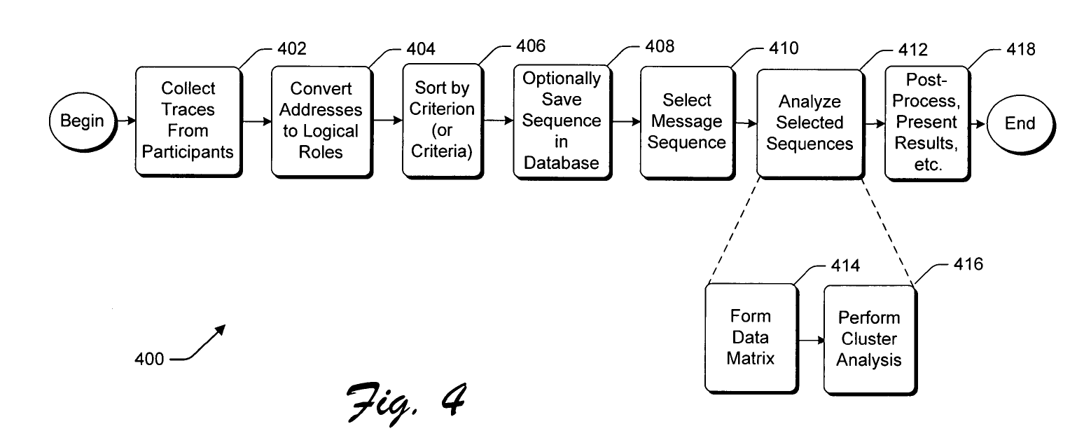

More specifically, the operation of forming sequences may involve extracting time information and/or other information from individual message traces, sorting the messages based on such information, and grouping the messages into sequences based on the results of the sorting. Additional information regarding this operation is provided in the context of FIG. 4 (to be described below in turn).

The “conversion” component of the message aggregation and conversion logic 302 converts machine-specific identifying information associated with the messages into logical or functional information associated with the respective roles that the machines serve in the message-passing environment 102. For example, if a machine functions as a client in a message exchange, then its machine-specific identifying code (that may be present in the message sent or received by it) is converted to a functional identifier that identifies this machine as a client. Additional information regarding this operation is also provided below in the discussion of FIG. 4.

The output of the message aggregation and conversion logic 302 can be stored in the data store 118. As shown in FIG. 3, the data store 118 includes a master collection 304 of message sequences, such as exemplary message sequence 306. As described above, each message sequence can include one or more messages arranged by time and/or other criteria.

Message sequence manager logic 308 generally manages the message sequence information stored in the data store 118. This logic 308 can specifically cull specific subsets of message sequences stored in the data store 118 based on specified criteria, and then store these subsets in the data store 118 for subsequent analysis. For instance, the data store 118 shows exemplary sequence subsets 310, 312 and 314. Subsets of sequences can be formed based on time, transaction type, participants involved in the message exchanges, and/or any other criteria depending on the objectives of the analyst 128 and the nature of the message-passing environment 102 involved.

Analysis logic 316 analyzes the one or more subsets of message sequences that have been grouped together by the message sequence manager logic 308. The analysis logic 316 can specifically perform cluster analysis on the sequences stored in the data store 118 to group these sequences into different clusters based on specified criteria. Alternatively, the analysis logic 316 can use other mechanisms for analyzing the messages sequences, such as artificial intelligence analyses, neural network analyses, various rule-based analyses, various kinds of statistical analyses, various kinds of pattern matching analyses, and so on. Still alternatively, the analysis can be performed manually, either in whole or in part, by a human analyst.

Finally, output logic 318 receives the results of the analysis logic 316 and converts such output into an appropriate form for presentation to the analyst 128. For instance, the output logic 318 can transform the output results for presentation in graphical format, tabular format, or some other kind of format.

The operations performed in each of the above-described logic modules will be described in greater detail in the next section.

B. Method of Operation

FIG. 4 illustrates an exemplary method 400 for performing message-based analysis using the system 100 of FIG. 1. In this figure, various algorithmic acts are summarized in individual “blocks.” Such blocks describe specific actions or decisions that are made or carried out as a process proceeds. Where a microcontroller (or equivalent) is employed, this method 400 provides a basis for a “control program” or software/firmware that may be used by such a microcontroller (or equivalent) to effectuate the desired control. In this case, the processes are implemented as machine-readable instructions or declarative statements storable in memory that, when executed by a processor, perform the various acts illustrated as blocks. While steps are shown as being performed in a prescribed order, it is possible to perform these steps in a different order.

Step 402: Collecting Traces

The method 400 begins in step 402, which entails collecting traces from participants in the message-passing environment 102. To arrange the messages based on time, it is necessary to associate time information with each captured message. In one case, time information is extracted from chronological information embedded in the messages themselves. This time might refer to when the message was created, when the message was sent, or based on some other information. Alternatively, or in addition, the observation agents (110, 112, 114, 116) can each provide a time stamp regarding when they intercepted the messages. Such time information may pertain to raw counter information, so it is useful to convert this information to more conventional time-based formats. Generally, because of the myriad of different ways that time can be extracted from the messages, it is necessary to arrive at a consistent methodology of interpreting time, and in turn, for synchronizing the different techniques for extracting time used in the message-passing environment 102. It is also possible to capture and preserve time information using multiple different techniques so as to provide multiple different “views” of the behavior of the message-passing environment 102. Various heuristics can also be used to assist in interpreting and harmonizing time information across traces; for instance, a message is considered sent before it is received.

Step 404. Converting to Logical Roles

Step 404 entails converting the descriptive information that defines the participants associated with the traces to more meaningful logical or functional descriptions. For example, analysis system 108 may initially collect message traces that identify the participants by machine-centric designators, such as “machine-012-xp” and “machine-043-2k.” Step 404 converts these absolute descriptors into more functional descriptors that describe the role that each participant serves in the transaction, such as “client” or “server.” Such mapping of absolute descriptors to logical descriptors can be performed by lookup mapping table, or user-assisted input. Alternatively, or in addition, such mapping can be performed using automatic analysis of the traces to discover the role that the participant is playing. For instance, such automatic analysis would classify a participant that sends a request schedule message as a client because this behavior is exhibited by a client and not a server.

Other logical designations besides client/server are possible. For instance, a peer-to-peer network may not be structured using the client-server approach. In the general case, the participants can be broken down into the broad category of sender and receiver; however, even this does not hold true when a message is sent but never received by its target. Further, in a broadcast/multicast mode of operation, a participant can send messages to plural recipients.

Steps 406 and 408: Forming Sequences

Step 406 entails sorting the messages captured in the traces based on various criteria, such as time, to form message sequences. The time synchronization provisions discussed above are applied here to provide a consistent ordering of messages based on time. Step 408 entails optionally storing the sequences formed in step 406 in a data store, such as data store 118.

Steps 402-408 can be performed by the message aggregation and conversion logic 302 shown in FIG. 3, or in another module.

Step 410: Grouping Sequences

Step 410 entails selecting a group of sequences from the data store 118 for the purpose of performing analysis on these sequences. For instance, the analyst 128 may be primarily interesting in investigating the behavior of a group of interacting participants at a certain time of day. In this case, step 410 can cull a subset of sequences that provide information regarding the participants of interest and the timeframe of interest.

Step 410 can be implemented using the message sequence manager logic 308 shown in FIG. 3.

Step 412: Analyzing Sequences

Step 412 entails actually performing analysis on the sequences selected in step 410. This step 412 can employ any type of analysis depending on the type of message-passing environment 102 being analyzed, and depending on the objectives/interests of the analyst 128. Exemplary types of analysis can include, but are not limited to: pattern matching analyses; any kind of rule-based analyses; artificial intelligence analyses; any kind of statistical analyses (such as cluster analysis); any type of neural network analyses, and so forth.

To provide one exemplary example, step 412 will be described below in the context of a cluster analysis strategy. Broadly stated, cluster analysis involves grouping items in a set of items into one or more groups or clusters based on various criteria. FIG. 4 shows that the cluster analysis includes two broad steps: forming a data matrix (in step 414) and performing cluster analysis based on the thus formed data matrix (in step 416). Each of these steps will be described below in greater detail.

As to step 414, a data matrix is formed from the selected message sequences to emphasize different collections of information present in the message sequences. For example, clustering can focus on specific re-try patterns, specific multi-response patterns, specific transport fault conditions, specific gateway/firewall errors, etc. Generally, the analyst 128 will typically select particular criteria for analysis based on the objectives of the test and the characteristics of the subject message-passing environment 102. For example, in one case, the analyst 128 may be interesting in performing functional tests to discover whether there are “bugs” in a software program used by one or more of the participants. In another case, the analyst 128 may be interested in investigating the performance of the message-passing environment 102 in order to better tune such environment 102 to improve its performance. Section C (below) provides additional information regarding exemplary applications of the analysis techniques described herein.

Two exemplary techniques are discussed here for forming a data matrix on which cluster analysis can be performed: feature-based techniques and similarity-based techniques.

In feature-based techniques, step 414 takes each message sequence and extracts numerical counts for different features present in the sequence. This could include combinations of message command/action types (such as “Purchase” and “Sell” in web-based commerce applications), sender/receiver pairs, properties of the message (e.g., “Secured” and “Reliable”), or application-level properties in the message (such as the number of shares in financial-type applications). Action types can be extracted from SOAP messages based on predefined XML information in the messages that specifies the action types associated with the messages. Information regarding the action can also be ascertained based on other parts of the messages, such as the HTTP header of the message.

For instance, step 414 can extract features corresponding to counts of message types. Consider, for example, the case of an illustrative sequence 0, in which a “request-schedule” message has occurred ten times, while a “schedule-response” message has occurred three times. The data matrix produced in this case would correspond to the following:

Exemplary Matrix Table 1

| Sequence | “request-schedule” | “schedule-response” | . . . |
|---|---|---|---|
| 0 | 10 | 3 | . . . |

Another technique that can be used for extracting features involves counting actions in pair-wise fashion between different participants in the message-passing environment 102. An exemplary algorithm for implementing this technique is as follows:

### Exemplary Algorithm 1

For each participant X:
For each participant Y:
   For each action A:
      Output From-To-A =“count A's from X to Y” In this algorithm, participants X and Y correspond to different messaging transmitting or receiving entities in the message-passing environment 102. However, in some cases, a participant X is the same as the participant Y, meaning that a single entity is both the transmitter and recipient of a message.

The following data matrix is produced using the above algorithm for exemplary participants labeled “C” and “S” (e.g., denoting client and server, respectively). The message actions appropriate to the exchange between these two participants are “request0” and “response0,” denoting a request made by one of the participants and a corresponding response made by the recipient of the request.

Exemplary Matrix Table 2

| | C—C- | C—C- | C-S- | C-S- | S-C- | S-C- | S—S- | S—S- |
|---|---|---|---|---|---|---|---|---|
| Sequence | request0 | response0 | request0 | response0 | request0 | response0 | request0 | response0 |
| 0 | 0 | 0 | 10 | 0 | 0 | 3 | 0 | 0 |

In this message sequence, participant “C” made ten requests to participant “S” (as denoted by the column labeled “C-S request0.” (In other words, the notation “X-Y” indicates that the message action flows from entity “X” to entity “Y.”) Further, in this sequence, entity “S” responded to entity “C” three times, (as denoted by the column “S-C response0” column). Post processing can be performed to remove columns that do not list any actions (i.e., that list the number 0). As the reader will appreciate, in an actual message-passing environment, the number of columns produced using the pair-wise approach described above may become relatively large. However, this does not necessarily present an obstacle to efficient processing of such a matrix, as the processing burden placed on some clustering algorithms grows, at worst, linearly with the number of columns or dimensions.

Another exemplary approach is to perform logical time ordering of data stored in the sequences. This approach can extract features depending on their chronological occurrence in a specified timeframe. For example, this approach can extract information depending on whether events took place before or after a specified point in time (denoted, respectively, by the labels “happened-before” and “happened-after”). The following algorithm constructs a data matrix based on such chronological considerations:

Exemplary Algorithm 2

For each participant X:

For each participant Y:

For each action A:

For each action B:

Output From-To-A-B-Before,
“count A's from X to Y which

happened-before B's from X to Y”

Output From-To-A-B-After,
“count A's from X to Y which

happened-after B's from X to Y”

This algorithm counts the number of actions “A” sent from participant X to participant Y that happened before an action B is sent from participant X to participant Y. This algorithm also counts the number of actions “A” sent from participant X to participant Y that happened after an action B was sent from participant X to participant Y. For instance, in the context of an online shopping message-passing environment, this algorithm could be used to determine how many times that a user viewed a certain category (or brand) of product before purchasing another category (or brand) of product.

Still another possible approach is to count the logical or physical time delays between messages. The following algorithm extracts features based on a delay-based paradigm:

Exemplary Algorithm 3

For each participant X:

For each participant Y:

For each action A:

For each header H:

Output From-To-A-H, “count A's
containing H from X to Y”

This algorithm counts action A's sent from X to Y providing that they have certain parameters in their header H (or fall within a certain range of such parameters). For instance, time information can be extracted from an IP header, SOAP header, or other kind of message network header. Alternatively, time information can be inferred from the time that the message was intercepted, as determined by the observation agent. Still other techniques are available for gauging time information from messages. Using this chronological information, it is possible to determine how long certain actions take to perform, or the amount of time between different actions, and so forth.

Other algorithms can be devised to extract different features from the messages depending on the objectives of the analyst 128, the type of message-passing environment 102 involved, the composition of messages, and/or other factors. In any event, the output of such feature extraction constitutes a multi-dimensional data matrix. Clusters are formed based on information in this matrix, as will be discussed in the context of step 416.

Still referring to step 414, the second technique for forming a data matrix is similarity-based analysis of the messages. In this technique, instead of directly extracting features from the sequences, each sequence is compared with other sequences to derive difference values that express differences between information associated with the sequences. That is, assume that messages X and Y include parameters x1 and y1, respectively. A data matrix is computed using the similarity technique by subtracting x1 from y1 to derive a difference value d. The algorithm can normalize the difference value by defining the similarity as: similarity=MaximumValue/(Calculated₁₃ Difference(x, y)+1.0), where the Calculated_Difference variable should return a value d such that 0≦d≦MaximumValue.

A variety of difference algorithms can be applied to calculate a similarity matrix, such as string/sequence matching. In this approach, if a message was not sent, the algorithm increases the difference count by M, and if a message was sent twice, the algorithm increases the difference count by N, and so on.

With the similarity technique, it is also possible to compare a set of sequences with a known sequence that has been collected and stored in advance. This known sequence may represent a baseline sequence that the analyst 128 is confident represents the proper or optimal functioning of the message-passing environment 102. In this case, the analyst 128 can form a difference matrix that reflects the deviation of the message-passing environment 102 being tested from the baseline known sequence. For example, using this technique, the analyst 128 can compare a “good” server trace with a measured/observed trace, or a known “bad” server trace with a measured/observed trace. In the former case, a sequence that diverges from a good server trace cluster might be indicative of a failed server; in the latter case, a sequence that is grouped with the bad server trace cluster might be indicated of a failed server.

In another case, the known sequence can be collected from another kind of message-passing environment, such as a related type of message-passing environment. In this scenario, an analyst can form a difference matrix that reflects how the message-passing environment 102 under consideration differs from related systems, such as systems produced by different computer or software manufacturers, or systems employing different processing strategies or software application versions. Such system-to-system comparisons may be particularly useful in analyzing specific re-try patterns, specific multi-response patterns, specific transport fault conditions, specific gateway/firewall errors, and so on. For example, an analyst can use this comparison technique to compare the behavior of two software programs (e.g., a Stock Purchase program and a Calendar program) that run on the same network configuration, even though the messages propagated between participants in these environments have different application-related content.

Once the data matrix has been formed, step 416 comes into play by forming clusters on the basis of information in the data matrix. Any type of clustering algorithm can be used to perform this task, such as algorithms using the partitional paradigm, agglomerative paradigm, graph-partitioned paradigm, etc. For example, one suite of clustering strategies that can be used is provided the CLUTO software package provided by George Karypis (Department of Computer Science & Engineering, Twin Cities Campus, University of Minnesota, Minneapolis, Minn.), which employs all of the above paradigms. The clustering step 416 can rely on one clustering algorithm to analyze the data set, or can combine several different clustering algorithms. In the latter case, the algorithm can automatically select the best approach by trying each one, or can combine the results of different approaches, or can iteratively converge on an optimal solution by repeating the clustering analysis with different settings or approaches.

In any case, the analyst 128 can control the clustering algorithm by selecting the number of clusters that should be created. In one implementation, the analyst 128 may want the clustering algorithm to group the sequences into clusters such that the ratio of the number of clusters produced to the number of initial sequences is about 15%. That is, if 100 sequences are used to form the data matrix, then the algorithm should produce about 15 clusters that group these sequences together.

Other settings allow the analyst 128 to specify the techniques used by the clustering algorithm to measure distances between clustered objects or the distances between objects and the clusters to which they are associated. For example, the analyst 128 may specify that the algorithm should compute this distance based on the square root of the distance between two objects instead of a normal distance. Alternatively, the analyst 128 may specify that the algorithm should measure the distance from an object to the nearest neighboring object in the cluster, or measure the distance from the farthest neighboring object in the cluster, or measure the distance from the weighted center of the cluster, and so on.

The output of step 416 comprises a listing of clusters and the sequences associated therewith. For instance, consider the case where seven sequences (numbered 0 through 7) were fed to the clustering algorithm. In this case, the output might be:

Cluster 0: Sequence 0, 5, 6

Cluster 1: Sequence 1, 2, 4

Cluster 2: Sequence 3

The above seven sequences might contain known reference sequences added to the group of sequences to assist in interpreting the results. Known reference sequences can correspond to sequences that reflect the error-free operation of the message-passing environment 102, or known failure conditions within the environment 102.

To repeat, step 412 is not limited to cluster analysis; other techniques can be used. For example, step 412 can compare the message sequences against a formal model of the system (e.g., provided by a state machine). This comparison can place each sequence in one of two “clusters,” corresponding respectively to whether each sequence adheres to the model or does not adhere to the model.

Step 418: Post-Analyzing and/or Presenting Results

Step 418 involves optionally performing additional analysis on the output of step 412. In the event clustering analysis was used in step 412, step 418 may entail performing post-analysis to select sequences that are “interesting.” Generally, the term “interesting” means different things depending on the objectives of the analyst 128. The analyst 128 might consider a sequence interesting because it is suggestive of a functional or performance-related error. Alternatively, the analyst 128 may be interested in identifying message sequences that are indicative of beneficial phenomena, such as instances when a message-passing environment performs particularly well. Still alternatively, the analyst 128 may be interested in identifying trends in activity within the environment for strictly marketing-related purposes. Section C below provides additional examples of possible applications of the method 400 shown in FIG. 4.

Whatever the analyst 128's objectives, the post-processing can entail a variety of techniques. The techniques can use automatic analysis of formed clusters using various rule-based systems, artificial intelligence systems, neural network systems, and so forth. Alternatively, the techniques can provide a visual presentation of the clusters to the analyst 128 and allow the analyst 128 to manually select interesting sequences based on his or her own informed judgment. Still alternatively, the post-analysis can comprise a combination of automated and manual techniques.

For example, step 418 may sort the formed clusters on the basis of the number of members in the clusters (from smallest to largest). The analyst 128 may then want to further examine the first N % of clusters in this ranked list. This is because small clusters of sequences may be indicative of particularly anomalous or interesting conditions that warrant further investigation. Clusters with only one member (i.e., singleton clusters) tend to be especially interesting. A small cluster does not necessarily represent an error or performance problem; however, such a small cluster has at least some feature or features which make it stand out from the other clusters.

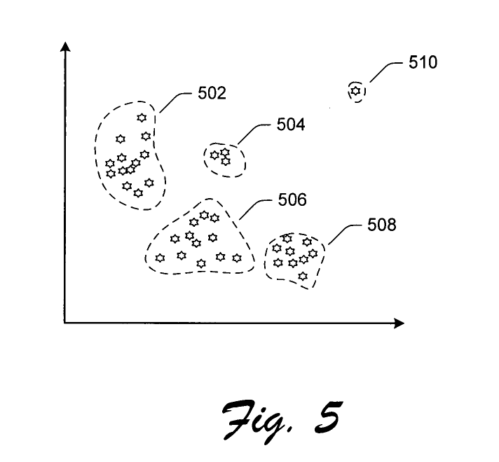

FIG. 5 shows an exemplary output of the method 400 of FIG. 4. The output consists of a two-dimensional presentation of the formed clusters (502-510). The axes of the graph can correspond to different attributes of the sequences. However, in other cases, the method 400 can present the output of the clustering process in another format, such as a table that simply ranks the clusters based on number of members in the clusters.

In the illustrative case shown in FIG. 5, clusters 502, 506, and 508 contain a relatively large number of members, while clusters 504 and 510 contain relatively few members. Hence, the analyst 128 might be particularly interested in performing further analysis on the sequences contained in clusters 504 and 510. The system 100 shown in FIG. 1 can partially automate this further analysis by linking each cluster to information regarding the sequences associated with the cluster. This can be performed via hypertext links or some other linking mechanism. More specifically, the system 100 could provide supplemental information such as information listing the actual messages in the identified sequences. Additionally, the system 1100 could be configured to perform additional automated analysis on the selected clusters upon the request of the analyst 128.

Various graphical aids could also be provided. For instance, the system 100 can present a schematic of the message-passing environment 102. Mapping logic can be provided that correlates interesting sequences with locations in the schematic corresponding to agents (participants) that may be associated with the interesting sequences. This might be particularly useful in identifying equipment that may be performing incorrectly or poorly.

C. Exemplary Applications

The analyst 128 can apply the method 400 shown in FIG. 4 to a great variety of investigative tasks. In one case, the analyst 128 might be interested in identifying sequences that either represent functional errors (e.g., the environment is producing inaccurate results), or performance-related problems (e.g., the environment may be producing accurate results, but is producing them in a substandard manner, that is, either too slow or by consuming too much memory, etc.).

Consider, for example, the following sequences produced by an environment that involves performing arithmetic operations (e.g., using a well-known GUI-based calculator program). The client and server mentioned below might refer to separate computers coupled together via a network, or separate modules within a single computer.
Sequence 1: Client sends message (“add 1, 2”), and server sends response (“3”).
Sequence 2: Client sends message (“add 3, 4”) but must retry sending ten times. Server is too busy to respond to the first nine requests, but finally sends one response to the tenth request (“7”).

Sequence 3: Client sends message (“plus 1, 2”), and server sends failure (“not supported”).
Sequence 4: Client sends message (“plus 3, 8”), but server is too busy and sends no response.

In these executions, the analyst 128 might be particularly interested in further examining sequences 2 and 4. This is because these cases have fundamentally different message exchange patterns compared to cases 1 and 3. Anomalous conditions might become even clearer upon collecting and analyzing a larger population of sequences. Generally, the method 400 can be used to identify outright coding errors, or to identify lack of coding sophistication (such as poor handling of re-try logic). The results can be used for debugging, for improving algorithms, and for deploying new policies that govern the message-passing environment 102.

The method 400 can also be used to identify transient circumstances that affect behavior yet may not be attributable to the participants that originate or receive the messages. For instance, consider the case where participant X sends a message to recipient Y through two different interface routes. One of these routes might perform substantially worse than the other. The method 400 can provide information which assists the analyst 128 in pinpointing the equipment that may be responsible for this discrepancy. For instance, the analyst 128 may come to the conclusion that a gateway is involved in one route that is performing poorly, e.g., by dropping packets. Such a conclusion can be reached even though the gateway may not affect the content of the messages being transmitted.

In still another application, the analyst 128 may be interested in identifying cases in which the environment performs particular well. The analyst 128 might want to study this phenomenon to determine what contributes to its success, so that this condition attributed to success can be duplicated in other parts of the environment on a more consistent basis.

Another application is to detect anomalous conditions in the message-passing environment 102 that may be suggestive of improper use of the environment. For example, the method 400 can be used to detect patterns of message exchange that are indicative of unauthorized access to network resources or fraudulent activity. Such patterns can emerge by investigating outlying clusters or small clusters. Also, the analyst 128 can interject know message patterns that are indicative of improper conduct into the analysis. In this case, the method 400 can provide an indication of improper conduct if it classifies collected message sequences with known “bad” sequences.

More generally, in this domain of analysis, the sequence of received messages is often as significant for analysis as the number of messages. The firewall used in a network environment might not be able to filter out prohibited message patterns because it operates using a stateless paradigm, and therefore is incapable of recognizing the connection between messages. Consider the case where the firewall may permit the exchange of both create-dialog and teardown chat-session messages, but a message sequence consisting of 10,000 teardown chat-session messages, one create-dialog message, and 10,000 more teardown chat-session messages might be suggestive of improper activity; being stateless, the firewall might not able to detect this problem, but the above-described method 400 can pick out this pattern.

Another application of the method is in the field of marketing. For instance, the analyst 128 may be primarily concerned with the patterns of purchasing behavior exhibited by users, rather than whether the message-passing environment is working properly. For instance, an analyst 128 can use the method 400 to determine various correlations relating to users' web browsing activities or online shopping activities. The method 400 can determine whether certain activities are prevalent in certain time periods, whether certain activities are associated with the other activities or events, and so on. The analyst 128 could use this information to improve the dissemination of products and services to individuals assessed to be most likely desirous of purchasing such products and services. The method 400 also provides a mechanism for non-commercial research (such as various academic or government-related studies of web usage).

The above applications are not limitative of the many uses of the method 400 shown in FIG. 4.

The benefits of this approach are likewise diverse. As explained above, one advantage is that the analyst 128 need not gain access to the equipment and systems being tested in order to analyze them. (However, the analyst 128 may have to take a more intrusive approach when analyzing the messages passed between components in a single machine, or between modules of program code; this is because these message events might not be accessible “on a wire” to parties that do not have direct access to the machine or program under investigation.)

D. Exemplary Computer Environment

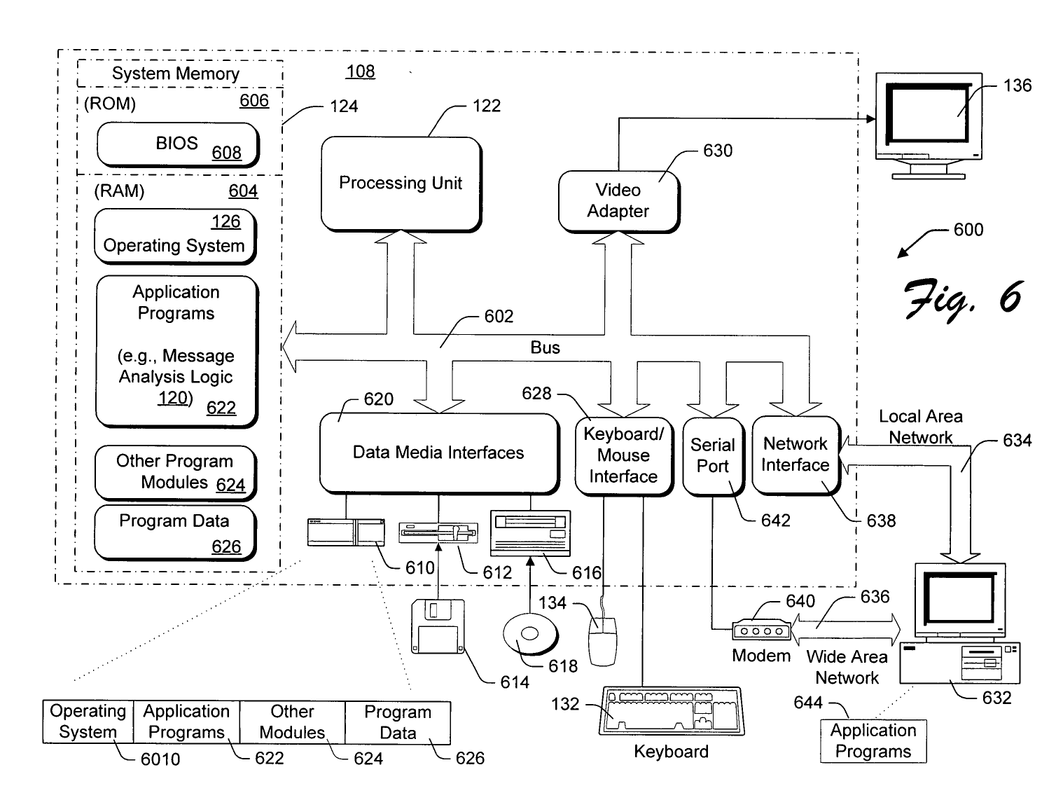

FIG. 6 provides additional information regarding a computer environment 600 that can be used to implement the analysis system 108 shown in FIG. 1. That is, the computing environment 600 includes the general purpose computer 108 and the display device 136 discussed in the context of FIG. 1. However, the computing environment 600 can include other kinds of computer and network architectures. For example, although not shown, the computer environment 600 can include hand-held or laptop devices, set top boxes, programmable consumer electronics, mainframe computers, gaming consoles, etc. Further, FIG. 6 shows elements of the computer environment 600 grouped together to facilitate discussion. However, the computing environment 600 can employ a distributed processing configuration. In a distributed computing environment, computing resources can be physically dispersed throughout the environment.

Exemplary computer 108 includes one or more processors or processing units 122, a system memory 124, and a bus 602. The bus 602 connects various system components together. For instance, the bus 602 connects the processor 122 to the system memory 124. The bus 602 can be implemented using any kind of bus structure or combination of bus structures, including a memory bus or memory controller, a peripheral bus, an accelerated graphics port, and a processor or local bus using any of a variety of bus architectures. For example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 108 can also include a variety of computer readable media, including a variety of types of volatile and non-volatile media, each of which can be removable or non-removable. For example, system memory 124 includes computer readable media in the form of volatile memory, such as random access memory (RAM) 604, and non-volatile memory, such as read only memory (ROM) 606. ROM 606 includes an input/output system (BIOS) 608 that contains the basic routines that help to transfer information between elements within computer 108, such as during start-up. RAM 604 typically contains data and/or program modules in a form that can be quickly accessed by processing unit 122.

Other kinds of computer storage media include a hard disk drive 610 for reading from and writing to a non-removable, non-volatile magnetic media, a magnetic disk drive 612 for reading from and writing to a removable, non-volatile magnetic disk 614 (e.g., a “floppy disk”), and an optical disk drive 616 for reading from and/or writing to a removable, non-volatile optical disk 618 such as a CD-ROM, DVD-ROM, or other optical media. The hard disk drive 610, magnetic disk drive 612, and optical disk drive 616 are each connected to the system bus 602 by one or more data media interfaces 620. Alternatively, the hard disk drive 610, magnetic disk drive 612, and optical disk drive 616 can be connected to the system bus 602 by a SCSI interface (not shown), or other coupling mechanism. Although not shown, the computer 108 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 108. For instance, the readable media can store the operating system 126, one or more application programs 622 (such as the message analysis logic 120), other program modules 624, and program data 626.

The computer environment 600 can include a variety of input devices. For instance, the computer environment 600 includes the keyboard 132 and a pointing device 134 (e.g., a “mouse”) for entering commands and information into computer 108. The computer environment 600 can include other input devices (not illustrated), such as a microphone, joystick, game pad, satellite dish, serial port, scanner, card reading devices, digital or video camera, etc. Input/output interfaces 628 couple the input devices to the processing unit 122. More generally, input devices can be coupled to the computer 108 through any kind of interface and bus structures, such as a parallel port, serial port, game port, universal serial bus (USB) port, etc.

The computer environment 600 also includes the display device 136. A video adapter 630 couples the display device 136 to the bus 602. In addition to the display device 136, the computer environment 600 can include other output peripheral devices, such as speakers (not shown), a printer (not shown), etc.

Computer 108 can operate in a networked environment using logical connections to one or more remote computers, such as a remote computing device 632. The remote computing device 632 can comprise any kind of computer equipment, including a general purpose personal computer, portable computer, a server, a router, a network computer, a peer device or other common network node, etc. Remote computing device 632 can include all of the features discussed above with respect to computer 108, or some subset thereof.

Any type of network can be used to couple the computer 108 with remote computing device 632, such as a local area network (LAN) 634, or a wide area network (WAN) 636 (such as the Internet). When implemented in a LAN networking environment, the computer 108 connects to local network 634 via a network interface or adapter 638. When implemented in a WAN networking environment, the computer 108 can connect to the WAN 636 via a modem 640 or other connection strategy. The modem 640 can be located internal or external to computer 108, and can be connected to the bus 602 via serial I/O interfaces 642 other appropriate coupling mechanism. Although not illustrated, the computing environment 600 can provide wireless communication functionality for connecting computer 108 with remote computing device 632 (e.g., via modulated radio signals, modulated infrared signals, etc.).

In a networked environment, the computer 108 can draw from program modules stored in a remote memory storage device 644. Generally, the depiction of program modules as discrete blocks in FIG. 6 serves only to facilitate discussion; in actuality, the programs modules can be distributed over the computing environment 600, and this distribution can change in a dynamic fashion as the modules are executed by the processing unit 904.

Wherever physically stored, one or more memory modules 124, 614, 618, 644, etc. can be provided to store the message analysis logic 120 shown in FIGS. 1 and 3.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for investigating messages passed in a message-passing environment, comprising:
collecting a plurality of messages from at least one participant in the message-passing environment;
assembling the messages into at least one message sequence;
analyzing said at least one message sequence to extract information regarding the message-passing environment; and
outputting the information.

2. The method according to claim 1, wherein the message-passing environment is a network environment including plural participants coupled together via a network.

3. The method according to claim 2, wherein the network uses an Internet Protocol to transmit messages between participants.

4. The method according to claim 2, wherein the messages express the information in one of a plurality of message formats.

5. The method according to claim 2, wherein the messages include information expressed in a markup language.

6. The method according to claim 5, wherein the markup language is the extensible markup language (XML).

7. The method according to claim 2, wherein the network uses Simple Object Access Protocol (SOAP) to transmit messages between participants.

8. The method according to claim 1, wherein the message-passing environment is a machine or system including plural interacting components that function as message participants.

9. The method according to claim 1, wherein the message-passing environment is a software program including plural interacting software modules that function as message participants.

10. The method according to claim 1, further comprising, after the collecting, converting identifying information pertaining to said at least one participant into an indication of a role played by the participant in the message-passing environment.

11. The method according to claim 1, wherein the assembling comprises combining multiple message traces into said at least one message sequence, each message trace pertaining to one or more messages transmitted by and/or received at a participant.

12. The method according to claim 1, wherein the assembling comprises assembling plural message sequences, and the analyzing comprises analyzing the plural message sequences.

13. The method according to claim 1, wherein the analyzing involves performing cluster analysis to group said at least one message sequence into at least one cluster.

14. The method according to claim 13, wherein the cluster analysis comprises:
forming a data matrix based on information in said at least one message sequence; and
forming said at least one cluster based on the data matrix.

15. The method according to claim 14, wherein the forming of the data matrix involves extracting features from said at least one message sequence.

16. The method according to claim 14, wherein the forming of the data matrix involves forming a similarity measure which measures the difference between said at least one message sequence and another message sequence.

17. The method according to claim 13, wherein the analyzing involves identifying results of the cluster analysis that may warrant further investigation.

18. The method according to claim 1, wherein the analyzing comprises comparing said at least one message sequence with a reference message sequence.

19. A computer readable medium including machine readable instructions for implementing the collecting, assembling, analyzing, and outputting recited in claim 1.

20. An apparatus for investigating messages passed in a message-passing environment, comprising:
message aggregation logic configured to collect a plurality of messages from at least one participant in the message-passing environment, and to assemble the messages into at least one message sequence;
analysis logic configured to analyze said at least one message sequence to extract information regarding the message-passing environment; and
output logic configured to output the information.

21. The apparatus according to claim 20, wherein the message-passing environment is a network environment including plural participants coupled together via a network.

22. The apparatus according to claim 21, wherein the network uses an Internet Protocol to transmit messages between participants.

23. The apparatus according to claim 21, wherein the messages express the information in one of a plurality of message formats.

24. The apparatus according to claim 21, wherein the messages include information expressed in a markup language.

25. The method according to claim 25, wherein the markup language is the extensible markup language (XML).

26. The apparatus according to claim 21, wherein the network uses Simple Object Access Protocol (SOAP) to transmit messages between participants.

27. The apparatus according to claim 20, wherein the message-passing environment is a machine or system including plural interacting components that function as message participants.

28. The apparatus according to claim 20, wherein the message-passing environment is a software program including plural interacting software modules that function as message participants.

29. The apparatus according to claim 20, wherein the message aggregation logic is further configured to convert identifying information pertaining to said at least one participant into an indication of a role played by the participant in the message-passing environment.

30. The apparatus according to claim 20, wherein the message aggregation logic is further configured to combine multiple message traces into said at least one message sequence, each message trace pertaining to one or more messages transmitted by and/or received at a participant.

31. The apparatus according to claim 20, wherein the message aggregation logic is further configured to assemble plural message sequences, and the analysis logic is further configured to analyze the plural message sequences.

32. The apparatus according to claim 20, wherein the analysis logic is configured to perform cluster analysis to group said at least one message sequence into at least one cluster.

33. The apparatus according to claim 32, wherein, in performing the cluster analysis, the analysis logic is further configured to:
form a data matrix based on information in said at least one message sequence; and
form said at least one cluster based on the data matrix.

34. The apparatus according to claim 33, wherein the analysis logic is configured to form the data matrix by extracting features from said at least one message sequence.

35. The apparatus according to claim 33, wherein the analysis logic is configured to form the data matrix by forming a similarity measure which measures the difference between said at least one message sequence and another message sequence.

36. The apparatus according to claim 32, wherein the analysis logic is further configured to identify results of the cluster analysis that may warrant further investigation.

37. The apparatus according to claim 20, wherein the analysis logic is further configured to compare said at least one message sequence with a reference message sequence.

38. A computer readable medium including machine readable instructions for implementing the message aggregation logic, the analysis logic, and the output logic of claim 20.

39. An apparatus for investigating messages passed in a message-passing environment, comprising:
means for collecting a plurality of messages from at least one participant in the message-passing environment;
means for assembling the messages into at least one message sequence;
means for analyzing said at least one message sequence to extract information regarding the message-passing environment; and
means for outputting the information.
